(19) United States
(12) Patent Application Publication
(10) Pub. No.: US 2014/0179337 A1
(43) Pub. Date: Jun. 26, 2014

(54) SYSTEMS AND METHODS FOR SELECTING AN OPTIMAL LOCATION SERVICE

(71) Applicants: YARON ALPERT, Hod Hasharoni (IL); HAIM ROCHBERGER, Tel Mond (IL)

(72) Inventors: YARON ALPERT, Hod Hasharoni (IL); HAIM ROCHBERGER, Tel Mond (IL)

(21) Appl. No.: 13/724,293

(22) Filed: Dec. 21, 2012

(51) Int. Cl. H04W 64/00

(52) U.S. Cl. CPC H04W 64/00
USPC 455/456.1

(57) ABSTRACT

Systems and methods are described herein for selecting a location service based, at least in part, on service availability, capability, and/or accuracy. In one instance, the selection may be based, at least in part, on which location service that may result in the least amount of power consumed by a user device. The selection may also be balanced between user preferences and application demands for accurate and timely location services information.

### TECHNICAL FIELD

This disclosure generally relates to systems and methods for selecting a location service to determine a location of a user device. The selection process may include selecting between cellular networks, satellite networks, access point networks, and personal area networks.

### BACKGROUND

A variety of location detection techniques or services are available for variety of user devices. The location services may use different techniques or hardware to determine the location of the user device. The locations services may also provide different levels of accuracy or performance. Based on these differences, the user device may be compelled to use varying amounts of processing, time, and power to determine its location. The user device's resources may be limited and the user device may be able to use different degrees of accuracy for particular tasks.

### BRIEF DESCRIPTION OF THE FIGURES

The features within the drawings are numbered and are cross-referenced with the written description. Generally, the first numeral reflects the drawing number where the feature was first introduced, and the remaining numerals are intended to distinguish the feature from the other noted features within that drawing. However, if a feature is used across several drawings, the number used to identify the feature in the drawing where the feature first appeared will be used. Reference will now be made to the accompanying drawings, which are not necessarily drawn to scale and wherein:

FIG. 1 illustrates a system for selecting a location service based on the capabilities of one or more location services and a user device in accordance with one or more embodiments of the disclosure

FIG. 2 illustrates a location service map that indicates the types of location services available over a geographic area and one or more capabilities of the location service over the geographic area in accordance with one or more embodiments of the disclosure.

FIG. 3 illustrates a flow diagram for a method for selecting a location service based on the capabilities of one or more location services and a user device in accordance with one or more embodiments of the disclosure.

FIG. 4 illustrates a flow diagram for a method for updating location service information for a user device in accordance with one or more embodiments of the disclosure.

### DETAILED DESCRIPTION

Embodiments of the disclosure are described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art.

This disclosure may describe systems, methods, and devices for selecting a location service based on the capabilities of one or more location services and user preferences related to the capabilities of the location services.

User devices may have limited resources to perform location determination functions or the user devices may be located in a geographic area that limits the availability of the locations services. Hence, the user device may be able to conserve its limited resources (e.g., power) by selecting a location service that is likely or known to be available. In another instance, the user device may also conserve resources by selecting a location service that uses a lower amount of power than other location services. In another instance, the user device may select a location service based, at least in part, on location service availability and power consumption used to determine the location of the user device.

In another embodiment, the user device may also use location information with varying degrees of accuracy. For example, the user device may include an application that uses location information related to the country or continent to determine relevant weather conditions, currency rates, or a time zone. In other instances, the user device may include an application that needs location information that is accurate to within a few meters. The application may provide driving or walking directions that provide turn-by-turn directions and needs location accuracy within a few meters to provide accurate instructions. In one instance, the user device may determine which location service to use based on the service availability, power consumption, location accuracy, or a combination thereof.

In another embodiment, the user device may receive location service information for a geographic area that includes the user device. The location service information may provide service availability information and location accuracy information for a geographic area. The user device may use that information to select a location service based on user preferences, application requirements, or default preferences that minimize power consumption when the user device is connected to a constant power supply (e.g., an electrical outlet). The user preferences may include, but are not limited to, location accuracy preferences, location service power consumption preferences, and/or location service preferences. The application requirements may include location accuracy requirements that the application may need to perform as intended. For example, the application may provide directions that enable the application to provide turn-by-turn instructions for a user driving a car or walking through a dense urban area with many streets.

In another embodiment, the user device may determine that a previously received location service information may no longer be valid. This may be due to the user device entering a new geographic area. For example, a user may take an airplane to travel across country or to another country and the previously received location service information may not include content that relates to the new location. The user device may request new location service information from a server that collects or determines location service information for a variety of geographic areas. In the event that new location service information is not available, the user device may use default historical information for that geographic region or may rely on default settings on which location service to use based, at least in part, on power consumption, location accuracy, and/or service availability.

Example embodiments of the disclosure will now be described with reference to the accompanying figures.

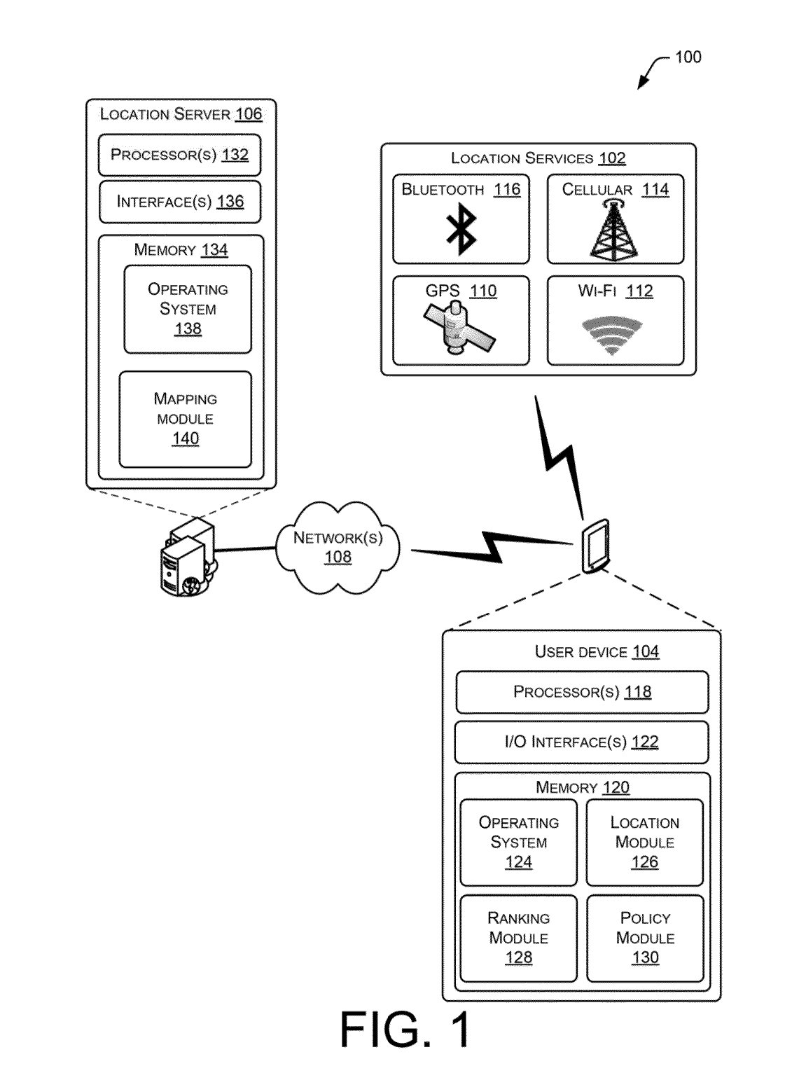

FIG. 1 illustrates a system 100 for selecting a location service 102 based on the capabilities of one or more location services 102 by a user device 104. A location server 106 may provide location service information to the user device 104 over a network 108. Broadly, the user device 104 may use the location services information to determine which location service to use to determine its location.

The locations services 102 may include, but are not limited to, global positioning systems 110 (e.g., satellite network), a Wi-Fi network 112 (e.g., access point network), a cellular network 114, or a Bluetooth network 116 (e.g., personal area network). More broadly, the location services 102 may pertain to any system or device that may provide any type of signal or information that may be used, by itself or in conjunction with other information or signals, to enable the user device 104 to determine its location.

The global positioning system 110 may include any satellite based system that may be used to provide location information to the user device 102. The satellite network (not shown) may include one or more satellites that transmit signals towards the surface of the earth. The signals may include the location of the satellite or the relative position of the satellite to the earth and a time of transmission from the satellite. The user device 104 may receive one more of the transmissions from one or more satellites. The location and timing information may be used to determine the location of the user device 102.

The satellite network may include a global service availability based on the satellites that are orbiting the earth on a continuous basis. The location accuracy of the satellite network service may be up to a few meters difference between the determined location and the real location of the user device 104.

The Wi-Fi network 112 may include access points (not shown) that send wireless signals to the user device 104. The Wi-Fi network 112 may include one or more access points that may be at a known location(s). The access point may send wireless signals that may include location information of the access point and the time the transmission was sent. The user device 104 may use that information to determine its location. In another embodiment, the user device 104 may send a signal to one or more access points that may use that information to determine the location of the user device 104 relative to the access points. This may include triangulation techniques that may include three or more access points. However, in certain instances fewer access points may be available, which may result in lower location accuracy. In contrast, when larger amounts of access points are triangulating the location, the location accuracy may be higher.

The cellular network 114 may include several radio transceivers distributed over a geographic area that provide voice and data communications for mobile devices (e.g., user device 104). Generally, depending upon the geography, the transceivers may be several kilometers apart. The transceivers may provide overlapping service areas to provide consistent communications service over the geographic area. In certain instances, the transceivers may be used to determine the location of the user device 104 based, at least in part, on receiving signals from the user device 104. In this way, the location of the user device 104 may be determined, but the location accuracy may be low. For example, when only one transceiver detects the user device 104, the location accuracy may be as large as the service area of the transceiver. The service area may be several square kilometers. In another instance, when several transceivers detect the signal from the user device 104, the location accuracy may be improved to within several meters. The information received at or from the transceivers may be used to triangulate the location of the user device 104.

The Bluetooth network 116 (e.g., a personal area network) may include wireless devices that may transmit and receive signals over a short distance (e.g., 10 meters). Typically, the Bluetooth devices may be tethered or networks with another device that may have a larger transmission range or that may be coupled to a network via a landline connection. Bluetooth devices that may be coupled to fixed or landline may be a known location. When the user device 104 is within the broadcast range of the Bluetooth device the location accuracy may be 10 meters. However, when the user device 104 may be in communication with several Bluetooth devices, the location accuracy may improve based on the triangulation techniques described above. In one embodiment, the Bluetooth device may be tethered to another mobile device, hence the location accuracy of the Bluetooth network may be dependent on whether the mobile device (not shown) is enabled to determine its location or knows its own location through other means. In this instance, the Bluetooth network may be dependent upon another network (e.g., a cellular network) to determine the location of the user device 104.

In one embodiment, the power consumed by the user device 104 to determine its location may vary based, at least in part, on the location service 102. In one instance, the relative power consumption from lowest to highest, my include a single cellular transceiver, using multiple cellular transceivers 114, GPS 110, Wi-Fi 112, and then Bluetooth 116. However, the power consumption may vary between different types of user devices 104 and may vary with changes in the location services 102. Additionally, new or other location services may need more or less power to be implemented on the user device 104. Broadly, user device 104 power consumption to determine a location is dependent upon the location service 102 and the capability of the user device 104. Generally, consuming less power is desirable; however, this variable may be balanced against other variables that will be described in greater detail below.

The user device 104 may include, but is not limited to: smartphones, mobile phones, laptop computer, desktop computer, tablet computers, televisions, set-top boxes, game consoles, in-vehicle computer systems, and so forth. The user device 104 may include, but is not limited to, one or more computer processors 118, memory 120, and/or interfaces 122.

The computer processor 118 to execute computer-readable instructions stored in memory 120 that enable the device to execute instructions on the hardware, applications, or services associated with the business. The one or more computer processors 118 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. In certain embodiments, the computer processor may be based on an Intel® Architecture system and the processor(s) 118 and chipset may be from a family of Intel® processors and chipsets, such as the Intel® Atom® processor family. The one or more processors 118 may also include one or more application-specific integrated circuits (ASICs) or application-specific standard products (ASSPs) for handling specific data processing functions or tasks.

The user device 104 may also include an Input/Output (I/O) interface 122 that enables a user to view content displayed by the device or to interact with the computer using various tactile responsive interfaces such as a keyboard, touch screen, or mouse. The I/O interface 122 may also include a wireless system that may enable the user device 104 to communicate wirelessly with the location service 102 and the location server 106. The wireless system may include the hardware and software to broadcast and receive messages either using the Wi-Fi Direct Standard (See; Wi-Fi Direct specification published in October 2010) and or the IEEE 802.11 wireless standard (See; IEEE 802.11-2007, published Mar. 8, 2007; IEEE 802.11n-2009, published October 2009) or a combination thereof. The wireless system may include a transmitter and a receiver or a transceiver (not shown) capable of operating in a broad range of operating frequencies governed by the 802.11 wireless standard.

The memory 120 may include an operating system 124 to manage and execute applications stored therein as well as other systems and modules within the computer. The memory 120 may be comprised of one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, or combinations thereof. The memory 120 may include, but is not limited to, a location module 126, a ranking module 128, and a policy module 130.

The location module 126 may communicate with the location services 102 and collect location services information provided by the location services 102 or the location server 106. The location services information may include, but are not limited to, the location of the components of the one or more location networks (e.g., GPS 110, Cellular 114, etc.) and the time the location information was transmitted by the components or received by the user device 104. The location module 126 may use the location and time information from several components to determine or triangulate the location of the user device 104. In one embodiment, the triangulation techniques may use spherical trigonometry or Euclidean geometry to determine the location of the user device 104. The accuracy of the determination increases when the amount of components providing location information to the user device 104 increases. Similarly, the location accuracy may decrease when the amount of components providing location information decreases.

In one instance, the location services information may also include the capabilities of the components that sent the information. For example, locations services information may include transmission power of the component or the effective transmission range of the component. In one embodiment, when the user device 104 is in communication with a single component of a location service 102, the user device 104 may use the range information to determine the location or location accuracy based on the information from the single component. For example, when the single component is a cellular transceiver, the range of the cellular transceiver may be several kilometers or more. Hence, the location accuracy based on the single cellular component may be relatively poor compared to a Wi-Fi component that has a range of 10 meters. Hence, the location module 126 may deduce the location accuracy based on the type of device or network that provided the single source location information. The accuracy of the single cellular transceiver information may be accurate in terms of kilometers while the accuracy of the Wi-Fi information may be accurate to within 10 meters.

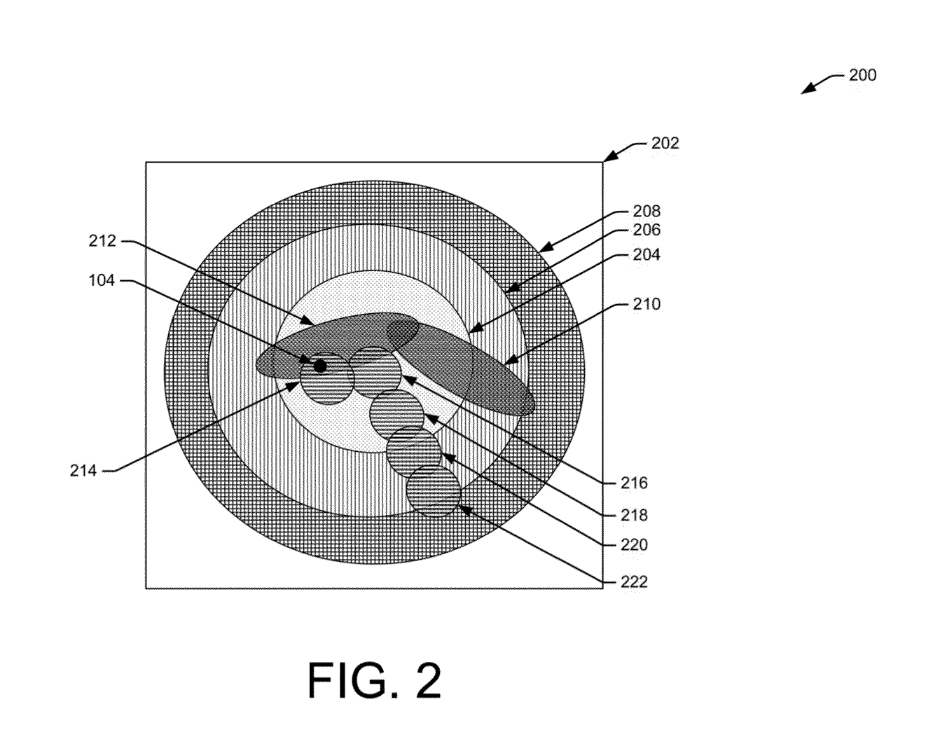

The ranking module 128 may receive location services information from the location server 106. The location server 106 may provide location services information about the locations services 102 over a geographic area (e.g., city, state, country, etc.). This information may include the service availability of the location services 102 over the geographic area. The information may also indicate service capability within the geographic area. For example, the location information may indicate where the location service is more reliable or more capable in comparison to other areas within the geographic area. The service availability and capability concepts will be discussed below in the discussion of FIG. 2. The ranking module 128 may rank the location services based on the service availability, service capability, user device power consumption, and policy preferences set by the user device 104 manufacturers, location service provider, the user of the user device 104, and/or an application stored on the user device 104. The ranking module 128 may initially rank the location services 102 based on availability and capability. In this instance, the higher ranking will be for location services 102 that are available near the user device 102 and may be the most capable. The capability may depend on the strength of the signals received from the location service 102 and the accuracy of the location service 102. In one embodiment, the user device 104 may receive location information from a single cellular transceiver (e.g., cellular network 114) and from an access point (e.g., Wi-Fi network 112). The ranking module 128 may rank the access point higher than the single cellular transceiver since the access point information may have better location accuracy. As noted above, the access point may indicate that the user device 104 is within 10 meters of the access point while the single cellular transceiver may indicate the user device may be anywhere within a several square kilometer area. However, the ranking module 128 may give the same ranking to each of the location services when the location accuracy may not be as important when the user device 104 may only need to know which state or country the user device 104 is located. In contrast, the ranking module 128 may rank the access point higher based on location accuracy when location accuracy is considered by itself without regard to how the user device 104 may use the location service 102.

However, the ranking module 128 may then rank the location services 102 based, at least in part, on power consumption of using the location service 102. In the example above, the ranking module 128 ranked the location services 102 (e.g., cellular and Wi-Fi) as equal based on location accuracy and service availability. However, using the cellular network 114 may consume less power than using the Wi-Fi network 112. Hence, the ranking module 128 may rank the cellular service 114 higher than the Wi-Fi network 112 based on power consumption. The power consumption may be provided by the location server 106, the location service 102, or may be stored on the user device 104.

The policy module 130 may determine which location service 102 to user based, at least in part, on the rankings and the user preferences or application preferences stored in memory 120. For example, the user may set a default preference to always use the location service 102 with the lowest power consumption when the user device 104 is operating under battery power. In another instance, the user preference may indicate using the lowest power consumption when the remaining battery life is below a certain threshold amount. For example, the lowest power location service may be used when the batter life is below 50% or any other percentage value set by the user or manufacturer of the user device 104. In another instance, the location service 102 selection may be balanced against the location accuracy, service capability, and/or service availability. For example, the policy module 130 may select between location services based, at least in part, on the needs of the application or processes being executed on the user device. For example, when the user device 102 executes a weather forecasting application, the user device 102 may just need to know the city, or state, to request a weather forecast. Therefore, the location accuracy may not be critical to executing that request. The user device 104 may be able to use either the cellular network 114 or the Wi-Fi network 112. Therefore, the policy module 130 may decide to use the location service based on power consumption. In this instance, the user device 104 may select the cellular network 112 due to being ranked higher on power consumption since it uses less power than the Wi-Fi network 112.

The policy module 130 may select locations services 102 based on the service capability or availability ranking. For example, the location module 126 may determine that a cellular network 114 with several cellular transceivers and a Wi-Fi network 112 with several access points are sending location information to the user device 104. The ranking module 128 may rank the location services on availability, capability, and/or power consumption. The policy module 130 may determine the user device 102 is executing a turnm-by-turn driving instruction application. In this instance, the policy module 130 may determine that location accuracy and service availability over a large geographic area may be desirable to implement the driving instruction application. The service availability information may include a refresh rate for each of the location services. Since the user device 104 may be changing locations quickly (e.g., highway driving) the location services with a higher refresh rate may be given a higher ranking. However, when the speed or rate of change in location of the user device 104 is low (e.g., lower than highway driving) the refresh rate ranking may be given a lower preference by the policy module. Hence, the location service 102 with the highest refresh ranking may not be selected. As shown above, the policy module 130 may balance competing rankings against the needs of the user device 104 applications and the user preferences. For example, the user preferences may indicate that the lower power consumption should be used under any circumstance or any other circumstance configured by the user.

The location server 106 may provide location services information or location services maps over the network 108 to the user device 104. The location server 106 may include, but is not limited to, one or more computer processors 132, memory 134, and interfaces 136.

The computer processors 132 may comprise one or more cores and are configured to access and execute (at least in part) computer-readable instructions stored in the one or more memories 134. The one or more computer processors 132 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The location server 106 may also include a chipset (not shown) for controlling communications between the one or more computer processors 132 and one or more of the other components of the location server 106. In certain embodiments, the location server 106 may be based on an Intel® architecture or an ARM® architecture and the computer processor(s) 132 and chipset may be from a family of Intel® processors and chipsets. The one or more computer processors 132 may also include one or more application-specific integrated circuits (ASICs) or application-specific standard products (ASSPs) for handling specific data processing functions or tasks.

The interfaces 136 may include coupling devices such as keyboards, joysticks, touch sensors, cameras, microphones, speakers, haptic output devices, memories, and so forth to the location server 106. The interfaces 136 may also comprise one or more communication interfaces or devices and/or network interface devices to provide for the transfer of data between the user device 102 and other devices. The communication interfaces may include, but are not limited to: personal area networks (“PANs”), wired local area networks (“LANs”), wireless local area networks (“WLANs”), wireless phone networks, wireless wide area networks (“WWANs”), satellite communication networks (e.g., GPS) and so forth. In FIG. 1, the location server 106 is coupled to the network 108 via a wired connection, but a wireless connection may also be used. The wireless system interfaces (not shown) may include the hardware and software to send and receive messages either using the Wi-Fi Direct Standard (See, Wi-Fi Direct specification published in October 2010) and or the IEEE 802.11 wireless standard (See; IEEE 802.11-2007, published Mar. 8, 2007; IEEE 802.11n-2009, published October 2009) or a combination thereof. The wireless system may include one or more transmitters and receivers or a transceiver (not shown) capable of operating in a broad range of operating frequencies governed by the IEEE 802.11 wireless standards or one or more of the following cellular standards: Global System for Mobile Communications (GSM™), Code Division Multiple Access (CDMA™), Universal Mobile Telecommunications System (UTMS™), Long Term Evolution (LTF™), General Packet Radio Service (GPRS™), High Speed Downlink Packet Access (HSDPA™), Evolution Data Optimized (EV-DO™). The wireless system may also include satellite based communications protocols like the global positioning system (GPS) or any other satellite communications protocols. The communication interfaces may utilize acoustic, radio frequency, optical or other signals to exchange data between the location server 106 and the network 108.

The one or more memories 134 may comprise one or more computer-readable storage media (“CRSM”). In some embodiments, the one or more memories 134 may include: non-transitory media such as random access memory (“RAM”), flash RAM, magnetic media, optical media, solid state media, and so forth. The one or more memories 134 may be volatile (in that information is retained while providing power) or non-volatile (in that information is retained without providing power.) Additional embodiments may also be provided as a computer program product including a transitory machine-readable signal (in compressed or uncompressed form).

Examples of machine-readable signals include, but are not limited to, signals carried by the Internet or other networks. For example, distribution of software via the Internet may include a transitory machine-readable signal. Additionally, the memory 134 may store an operating system 138 that includes a plurality of computer-executable instructions that may be implemented by the computer processor 132 to perform a variety of tasks to operate the interface(s) 136 and any other hardware installed on the location server 106. The memory 134 may also include a mapping module 140 and a location device module 142. In one embodiment, the wireless system may include a radio unit that includes antennas, transmitters, receivers, or transceivers that may transmit or receive signals over the ranges of the electromagnetic spectrum.

The mapping module 140 may determine the location services 102 that are available over one or more geographic areas. This may include collecting service area maps from the location service providers or from other sources that may record the availability information. In one specific embodiment, the other sources may include user device 104 that are using or have used location services within the one or more geographic area. The mapping module 140 may also determine the capabilities of the location services 102 in the one or more geographic areas.

This information may indicate how the location services capability may change within the one or more geographic areas. For example, the cellular service may provide high-speed data communication capabilities within populated areas, but the capabilities of the location service may be less in less populated areas. For example, the density of the cell towers within the cellular network within the city may be higher than the cell towers in a rural region.

The mapping module 140 may provide location services information in a way that the user device 104 may be able to determine the differences in availability, capability, and/or accuracy in the location services 102 for one or more locations within one or more geographic areas. One way to illustrate the differences would through a location services map that may provide an indication of availability, capability, and/or accuracy.

FIG. 2 illustrates a location service map 200 that indicates the types of location services available over a geographic area. In one embodiment, the locations services map may include an indication of service availability. In another embodiment, the location services map 200 may also include availability, capability, and/or accuracy of the locations services within a geographic area. In FIG. 2, the location services map 200 illustrates a combination of availability, capability, and accuracy that may encompass an geographical area (not shown). In this embodiment, the service area 202 of the GPS network is shown to accessible throughout the entire geographical area. Generally, the GPS network 110 may provide uniform available, capability, and accuracy as shown by the service area 202 that encompasses the entire geographical area. However, the capability of the GPS network 110 may vary due to the positioning of the satellites, the variations in capability and/or accuracy is not shown in the embodiment.

A cellular network 114 is illustrated using several elements that indicate the availability, capability, and accuracy. The center region 204 may indicate the availability of the cellular location service that may include a first density of cellular transceivers and/or an first capability to handle a higher rate of location services information. The middle region 206 may indicate the availability of the cellular location services that may include a second density of cellular transceivers and/or a second capability to handle a certain rate of location services information. In one instance, the rate of locations services for the middle region 206 may be lower than the rate found in the center region 204. The center region 204 may be representative of a downtown or city area and the middle region may be a suburban area that has lower service demands than the center region 204. The outer region 208 may indicate the availability of cellular location services in a rural region. In certain instances, the capability of the outer region may be different than the capability or accuracy of the center region 204 and the middle region 206. In one specific embodiment, the outer region 208 may encompass a geographic region that include fewer cellular transceivers than the center region 204 and the middle region 206. Hence, the accuracy of the outer region 208 may less than the accuracy of the two inner regions. In this embodiment, the location services map 200 may also include two high density areas that the cellular network 114 covers with additional transceivers or more capable transceivers. The high density regions 210, 212 may support a specific geographic region within the geographic area. For example, the high density regions 210, 212 may cover high population areas or high traffic areas. In these high density areas, the capability or accuracy of the cellular network 114 may be improved for those specific areas. The location services map 200 is not limited to GPS 110 and cellular networks 114.

In this embodiment, the location services map 200 may also include Wi-Fi networks 214, 216, 218, 220, 222 that cover portions of the geographic area that are support by the GPS 110 and cellular networks 114. The Wi-Fi networks are not shown to scale with respect to their coverage ranges (e.g., 10 meters) and the cellular network ranges of tens of kilometers. They are presented here as examples of how several networks may overlap within a geographic area. In this embodiment, each of the circular Wi-Fi regions may represent a signal access point or a group of access points.

In this embodiment, the user device 104 may be located within the geographic area. As shown in FIG. 2, the user device 104 is in a region that is overlapped by the center region 204, a high density region 212, and a Wi-Fi region 214. When power consumption is less of a priority than refresh rate, the user device 104 may choose to use the Wi-Fi region 214 to receive location information services. However, when the accuracy requirement for the user device 104 needs to higher than the access point may allow, the user device may select the GPS 202, center region 204, or the high density region 212. In view of a power consumption limitation, the user device 104 may choose the location service 102 that uses the least amount of power to determine a location. In this case, the cellular service (e.g., center region 204 or high density region 212) may be used to receive location services information. However, if the accuracy requirement is determined to be a higher priority than power consumption, the user device 104 may select the GPS network 110 since it may have a higher accuracy capability than the cellular network 114.

By using the information in the location services map 200, the user device 104 may be able to select a location service 102 that may meet the needs or preferences established by the user device 104. Accordingly, the user device 104 may select the location service based on the availability, capability, and accuracy of each of the location services.

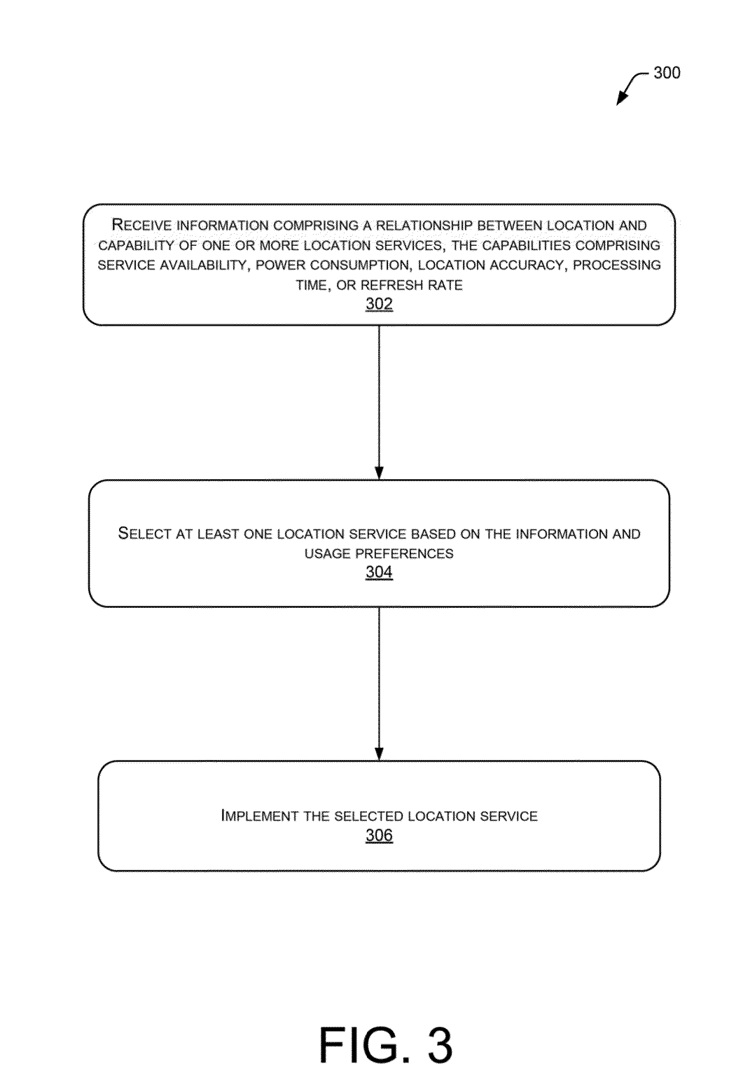

FIG. 3 illustrates a flow diagram for a method 300 for selecting a location service based on the availability, capability, and/or accuracy of one or more location services by a user device 104. Broadly, the user device 104 may receive location services information that may enable a selection of a location service 102 based, at least in part, on the preferences or needs or the user or the applications stored on the user device 104. The method 300 illustrates another embodiment on the transfer of information may occur between the user device 104 and the location server 106. It should be noted that in other embodiments, the sequencing of the method 300 may be altered and some steps may be omitted.

At block 302, the user device 104 may receive location services information that may include a relationship between at least one geographic location and one or more capabilities of one or more location services. In one embodiment, the capabilities may include service availability, location accuracy, and/or processing time. As noted above, the service availability may be an indication of where or when the one or more locations services are available for the at least one geographic location. The location services information may provide an indication of whether the user device 104 is in a location to receive the location information from one or more networks. In one embodiment, the networks may include a GPS 110, Wi-Fi 112, cellular, 114, and/or Bluetooth 116 (e.g., personal area network). The location accuracy may be an indication of a difference between an actual location of the user device 104 and a location of the user device 104 determined based, at least in part, on the locations services information. The processing time may be an indication of how long the one or more locations services will take to determine a location of the system or to provide the location services information to the user device 104. The capabilities may also include a refresh rate that may indicate how long it takes to receive updates from the one or more location services.

In one embodiment, the one or more locations services may include one or more of the following: a cellular network, a satellite network, an access point network, or a personal area network.

At block 304, the user device 104 may select at least one of the location services based, at least in part, on the information and user preferences. The user preference may include, but are not limited to, power consumption, location service accuracy, or information refresh capability. As noted above, the user device 104 may rank the information and compare the rankings to the user preferences. Based, at least in part, on this comparison the user device 104 may select one or more of the location services to use to determine the location of the user device 104. The user preferences may include power consumption or accuracy requirements for the applications stored on the user device 104. For example, a weather application may not require the same location accuracy as a turn-by-turn driving instruction application. Hence, the user device 104 may select a relatively less accurate location service to meet the information demands of the weather application. In this case, the user device 104 may select a location service that may use the lowest amount of power to determine the location. For example, the user device 104 may select to receive location information from a single cellular transceiver rather than attempt to triangulate a location from several cellular transceivers.

At block 306, the user device 104 may implement at least one of the selected location services based, at least in part, on the selection. The user device 104 may continue to use that location service until the user device 104 is no longer within that service area of that location service 102. In another instance, the user device 104 may need to use another location service with different capabilities that may not be provided by the current location service. In that case, the user device 104 may repeat one or more of the steps of method 300.

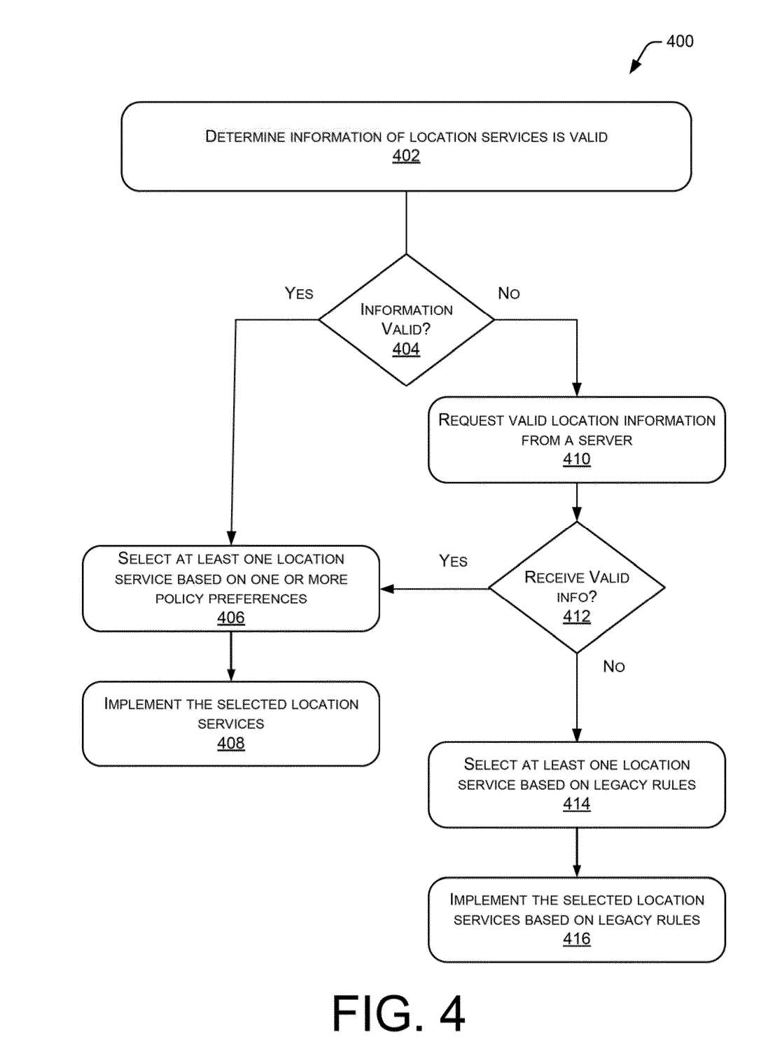

FIG. 4 illustrates a flow diagram for a method 400 for updating location service information for a user device 104 when the current location services information may be no longer valid. In certain embodiments, the location services map 200 may change over time or the user device 104 may enter a new geographic area that may not be supported by the location service map 200 stored in memory 120. Hence, the user device 104 may need up to verify the location services information is valid and request new information when the location services information is not valid. The method 400 illustrates one embodiment on the transfer of information may occur between the user device 104 and the location server 106. It should be noted that in other embodiments, the sequencing of the method 300 may be altered and some steps may be omitted.

At block 402, the user device 104 may determine whether the location services information stored in memory 120 is still valid. In one embodiment, the user device may estimate its location based on the movement of the user device 104. In this instance, the user device 104 may use an accelerometer to determine when the user device 104 has moved. This determination may also include determining the amount of movement and may determine the user device may be in another geographic area not covered by the current locations services information.

In another embodiment, the user device 104 may listen for location services information being broadcasted. For example, the user device 104 may detect GPS signals or signals from an access point that is known to the user device 104. In this way, the user device 104 may use readily available signals or communications that may indicate whether the user device 104 has moved.

In another embodiment, the user device 104 may also send a request to a location service, such as a cellular network 114. The request may include a confirmation of the nearby cellular transceiver to confirm the identity or location of the cellular transceiver. When the cellular identity is unchanged, the user device 104 may continue to use the location services map 200 stored in memory 120.

However, when the user device 104 determines that its location estimate is outside the geographic area of the locations services map 200. The user device may attempt to obtain a new map from the location server 106. In another instance, when the estimated location does not correlate with location services map 200, the user device 104 may also request an update location services map from the location server 106. In this case, the user device 104 may expect certain types of location services or network availability. When the expected service or network is not available, this may be an indication that the user device 104 has moved to a new location or that the underlying conditions of the locations services map 200 have changed and need to be updated.

At block 404, when the location services information is valid, the user device 104 may proceed to block 406 of the method 400. However, when the location services information is invalid, the user device 104 may proceed to block 410 of the method 400.

At block 406, the user device 104 may select one or more locations services based, at least in part, on one or more policy preferences. This may include the preferences that are described above in the description of block 304 in FIG. 3.

At block 408, the user device 104 may implement the selected information services in a similar manner as described in the description of block 306 in FIG. 3.

At block 410, the user device 104 may request updated location services information when the current location services information is deemed to be invalid. The request may be provided to the location server 106.

At block 412, the user device may receive the updated locations services information that may include updated location accuracy information for a current location of the user device 104. The user device 104 may confirm the new location services map is valid by listening for any communications traffic that may be originating from nearby location services or other networks in the geographic area. When the new location services map is deemed valid, the method 400 may continue to block 406 and then to block 408. However, when the new location services map is deemed invalid, the method 400 may proceed to block 414. The new location services may be deemed invalid based, at least in part, on inconsistent communication information that does not match or overlay with the new locations services map. For example, the new map may indicate the user device 104 should be within two or more Wi-Fi networks and near three cellular transceivers. However, when one or more of the expected networks or transceivers are not identified nor do not respond to queries, the user device 104 may determine the new map is not valid.

At block 414, the user device 104 may select one or more location services based on legacy rules or a prior location services map 200. In this instance, the user device 104 may select the GPS network to confirm its location, since the GPS network may be the most accurate and has the widest service area. In another instance, the user device 104 may scan of any cellular, Wi-Fi, or Bluetooth network to attempt determine its location.

At block 416, the user device 104 may implement one or more of the selected location services. When the user device 104 determines its location, the user device may implement the method 400 again to determine the validity of the previously received location service maps or to request another location service map from the location server 106.

### CONCLUSION

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritables (CD-RWs), magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware.

Various features, aspects, and embodiments have been described herein. The features, aspects, and embodiments are susceptible to combination with one another as well as to variation and modification, as will be understood by those having skill in the art. The present disclosure should therefore, be considered to encompass such combinations, variations, and modifications.

The terms and expressions, which have been employed herein, are used as terms of description and not of limitation. In the use of such terms and expressions, there is no intention of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the disclosure have been described in connection with what is presently considered to be the most practical and various embodiments, it is to be understood that the disclosure is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the disclosure, including the best mode, and to enable any person skilled in the art to practice certain embodiments of the disclosure, including making and using any devices or systems and performing any incorporated methods. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A system comprising:
at least one memory that stores computer-executable instructions; and
at least one processor execute the computer-executable instructions to:
receive information comprising a relationship between at least one geographic location and one or more capabilities of one or more location services, the capabilities comprising service availability, location accuracy, or processing time;
select at least one of the location services based, at least in part, on the information and user preferences; and
implement at least one of the selected location services using a communications component.

2. The system of claim 1, wherein the service availability is an indication of where or when the one or more locations services are available for the at least one geographic location.

3. The system of claim 1, wherein the location accuracy is an indication of a difference between an actual location of the system and a location of the system determined by using the information.

4. The system of claim 1, wherein the processing time is an indication of how long the system will take and power required to determine a location of the system, based at least in part, on the information.

5. The system of claim 1, wherein the one or more locations services comprise at least one or more of the following: a cellular network, a satellite network, an access point network, or a personal area network.

6. The system of claim 1, where the user preferences comprise power consumption, location service accuracy, or location information refresh capability.

7. The system of claim 1, wherein the capabilities further comprise refresh rate between location updates from one or more location services.

8. A method comprising:
receiving information comprising a relationship between at least one geographic location and a location accuracy of one or more location services;
selecting, using a processor, at least one of the location services based, at least in part, on the location accuracy of the one or more location services and power consumption of the one or more location services on a user device; and
determining a location of the user device based, at least in part, on the one or more of the selected location services.

9. The method of claim 8, further comprising:
determining the information is valid based, at least in part, on an estimate of a location of a user device;
requesting updated information based, at least in part, on determining the information is invalid;
receiving the updated information comprising updated location accuracy information for a current location of the user device;
selecting at least one or more of the locations services based, at least in part, on the updated information; and
determining another location of the user device based, at least in part, on the selected locations services based, at least in part, on the updated information.

10. The method of claim 8, wherein the estimate of the location is based, at least in part, on a cellular network, a satellite network, or an access point network.

11. The method of claim 8, wherein the location accuracy is an indication of the maximum distance between an actual location of the user device and a calculated location of the user device from the one or more location services.

12. The method of claim 8, wherein the power consumption is based, at least in part, on a minimum amount of power to determine the location of the user device.

13. The method of claim 8, wherein the selecting of the at least one of the location service is further based, at least in part, on a minimum amount of time to determine the location of the user device or a maximum amount of time to determine the location of the user device.

14. One or more tangible computer-readable storage media comprising computer-executable instructions operable to, when executed by at least one computer processor, enable the at least one computer processor to implement a method comprising:
receive location service information indicating one or more capabilities of at least one location service over a geographic area, the capabilities comprising service availability or location accuracy for the one or more location services that can determine a location of a user device;
select at least one of the location services based, at least in part, on the location service information and power consumption of the user device to use the at least one or more location services; and
implement at least one of the selected location services using a communications component.

15. The one or more tangible computer-readable storage media of claim 14, further comprising:
determine the user device has changed locations; and
request the location service information when a previous version of the location service information lacks content related to the changed location.

16. The one or more tangible computer-readable storage media of claim 14, wherein the power consumption is a lowest power consumption amount to determine a location of the user device.

17. The one or more tangible computer-readable storage media of claim 16, wherein the selection of the at least one location services is further based, at least in part, on a location accuracy preference to determine the location of the user device.

18. The one or more tangible computer-readable storage media of claim 14, wherein the selection of the at least one location services is further comprises:
determining a minimum location accuracy preference for the user device or an application stored on the user device; and
determining which of the at least one location services comprises a capability to determine a location of the user device within the minimum location accuracy preference using a lowest power consumption amount.

19. The one or more tangible computer-readable storage media of claim 14, wherein the selection of the at least one location services is further comprises:
determining a minimum location refresh rate for the user device or an application stored on the user device;
determining which of the at least one location services comprises:
a capability to determine a location of the user device within the minimum location accuracy preference using a lowest power consumption amount; and
a capability to meet the minimum location refresh rate.

20. The one or more tangible computer-readable storage media of claim 14, wherein the selection of the at least one location services is further comprises:
determining a minimum time to determine a location for the for the user device;
determining which of the at least one location services comprises a capability to determine the location of the user device within the minimum time.
